(19) United States
(12) Patent Application Publication
(10) Pub. No.: US 2009/0064577 A1
(43) Pub. Date: Mar. 12, 2009

(54) Circulating growing apparatus for breeding and cultivating together

(76) Inventor: Ching-Hui Lee, Guangzhou City (CN)

Correspondence Address: ROSENBERG, KLEIN & LEE, 3458 ELLICOTT CENTER DRIVE-SUITE 101, ELLICOTT CITY, MD, 21043, US

(21) Appl. No.: 11/896,965

(22) Filed: Sep. 7, 2007

(51) Int. Cl. A01G 31/02

(52) U.S. Cl. 47/62 R

(57) ABSTRACT

A circulating growing apparatus includes several circulating mechanisms, and cultivation troughs for cultivating plants; the circulating mechanisms are arranged in a breeding pool used to breed fishes/domestic birds, near to peripheries of the breeding pool, and will revolve 360° when they are powered; the circulating mechanisms each include several revolving support members spreading in the breeding pool; the cultivation troughs are each pivoted at two ends thereof to two adjacent ones of the revolving support members such that the cultivation troughs will come into contact with water in the breeding pool in order for the plants planted thereon to be nourished with nutrients in the water when the circulating mechanisms are revolving.

### BACKGROUND OF THE INVENTION

1. Field of the Invention

The present invention relates to a circulating growing apparatus, more particularly one, which can be used for breeding and plant cultivating together in order for users to make the best of land sources.

2. Brief Description of the Prior Art

The farming and breeding industry are aware that their competitiveness largely depends on how well they increase productivity and utilize land resources, which are reducing in size very rapidly and getting more expensive. Either soil or water can be used as the medium for plant cultivation. When plants are planted on soil, the soil will serve to hold the plants in position and provide various nutrients to the plants. When water is used as the medium for plant cultivation, the plants will have to be held in place by means of other artificial media, and will be nourished with various nutrients in water, e.g. nitrogen, phosphorus, potassium, carbon, hydrogen, oxygen, calcium, magnesium, sulfur, iron, zinc, boron, copper, chlorine, molybdenum, and manganese. No matter which one of the above methods is used to cultivate plants on a piece of land, the land won't be able to serve other purposes at the same time.

The waste from domestic-birds such as chickens, ducks, and gooses will cause environmental and water pollution if it isn't properly disposed. Furthermore, the fish breeding industry has developed an economical and ecologically reasonable method for breeding fishes; according to the method, water in breeding pools, which contains abundant nutrients produced from breeding fishes, is utilized to increase the production. However, currently, fertile water in fish breeding pools is utilized to serve other purposes except for what has been said above. Therefore, the abundant nutrients such as oxygen, phosphorus, calcium, and magnesium produced from breeding fishes will be wasted. Furthermore, the farming and breeding industry expect themselves to make the best of the limited land resources, which have been exploited to an undue extent, in order to help to protect the environment.

### SUMMARY OF THE INVENTION

It is a main object of the present invention to provide a circulating growing apparatus for breeding fishes/domestic birds and cultivating plants together to overcome the above problems.

A circulating growing apparatus according to an embodiment of the present invention includes several circulating mechanisms, and cultivation troughs for cultivating plants. The circulating mechanisms are arranged in a breeding pool used to breed fishes/domestic birds, near to peripheries of the breeding pool, and they can revolve 360°. Each of the circulating mechanisms includes several revolving support members spreading in the breeding pool. The cultivation troughs are each pivoted at two ends to two adjacent ones of the revolving support members such that the cultivation troughs will come into contact with water in the breeding pool in order for the plants planted thereon to be nourished with nutrients in the water when the circulating mechanisms are revolving. Therefore, land resources can be fully utilized, and the circulating growing apparatus is ideal in terms of environmental protection.

### BRIEF DESCRIPTION OF THE DRAWINGS

The present invention will be better understood by referring to the accompanying drawings, wherein:

FIG. 1 is a perspective view of the present invention,

FIG. 2 is a partial perspective view of the present invention,

FIG. 3 is a view of the cultivation trough of the present invention,

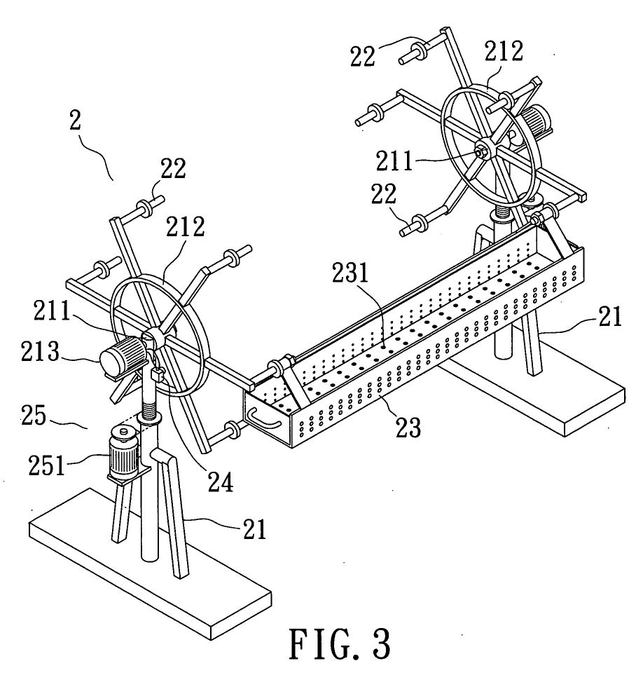

FIG. 4 is a partial perspective view of the present invention with the cultivation trough being to moved to gather the harvest,

FIG. 5 is a perspective view of the present invention in use,

FIG. 6 is a side view of a second preferred embodiment of the present invention (1),

FIG. 7 is a side view of the second preferred embodiment (2),

FIG. 8 is a side view of the second preferred embodiment (3),

FIG. 9 is a perspective view of the present invention in such a position for gathering the harvest/sowing, and

FIG. 10 is a side view of the present invention in such a position for gathering the harvest/sowing.

### DETAILED DESCRIPTION OF THE PREFERRED EMBODIMENTS

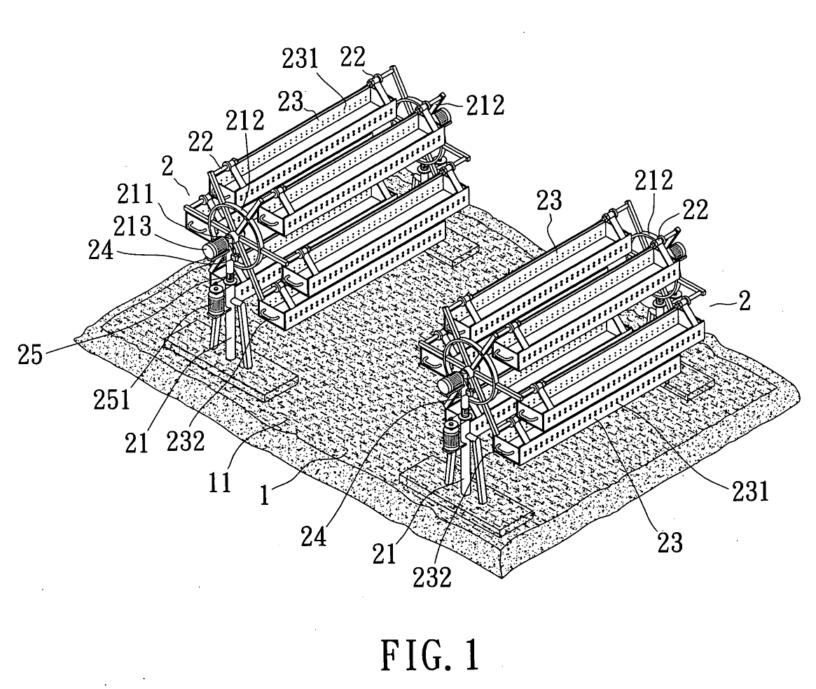

Referring to FIG. 1, a first preferred embodiment of a circulating growing apparatus of the present invention includes circulating mechanisms 2 for plants, which are arranged in a breeding pool 1 for breeding fishes/domestic birds, near to peripheries of the breeding pool 1, and which will revolve 3600 when they are powered. The circulating mechanisms 2 each include several revolving support members 21 spreading in the breeding pool 1. Each of the revolving support members 21 includes several equidistantly spaced connecting parts 22. The circulating growing apparatus of the present invention further includes cultivation troughs 23 for plants, which are each joined at two ends to corresponding said connecting parts 22 of two adjacent ones of the revolving support members 21. Therefore, the cultivation troughs 23 will come into contact with water in the breeding pool 1 when the circulating mechanisms 2 are revolving.

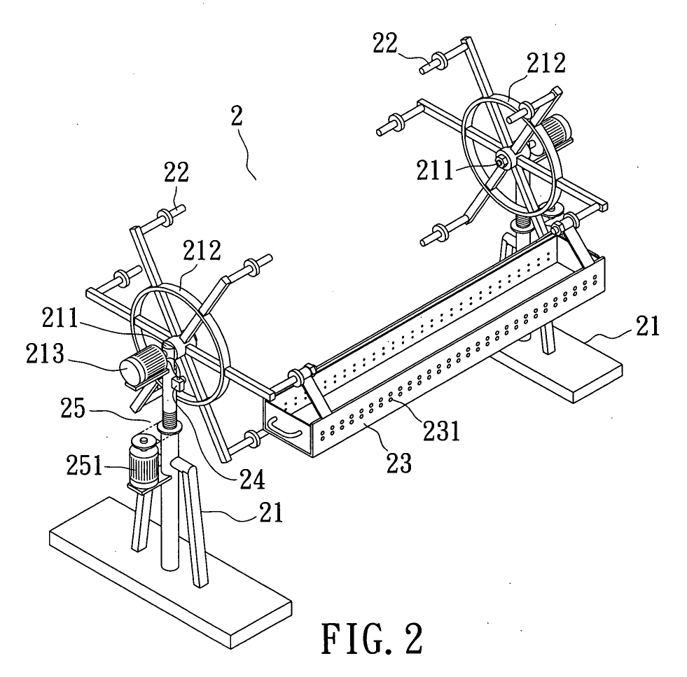

Referring to FIG. 2, in installation, first the revolving support members 21 are secured on a base 11 of the breeding pool 1 so as to stick out from the water of the breeding pool 1 at an upper pivotal portion 211 thereof. Each of the pivotal portions 211 of the revolving support members 21 has a rotating disk 212 pivoting thereon. Each of the rotating disks 212 has several equidistantly spaced connecting parts 22 thereon. The cultivation troughs 23 are each pivoted at two ends thereof to corresponding said connecting parts 22 of two adjacent ones of the revolving support members 21. The cultivation troughs 23 each have several water inlet holes 231 on the lateral sides/bottom thereof. Therefore, the cultivation troughs 23 will come into contact with water in the breeding pool 1, and water will flow into the cultivation troughs 23 through the water inlet holes 231 when the rotating disks 212 are powered to revolve by a power source 213 such as a motor.

Furthermore, the circulating growing apparatus is equipped with a time series controlling device 24 to control the power source 213 according to various factors such as classifications of plants, soils, water cultivation, weather, and water quality. For example, the time series controlling device 24 controls the power source 213 in order for the rotating disks 212 of the revolving support members 21 to be rotated at such a speed that each of the cultivation troughs 23 fitted on one said rotating disk 212 is immersed in water for ten minutes at a time. Alternatively, the rotating disks 212 of the revolving support members 21 can be rotated at such a speed by the power source 213 that every one of the cultivation troughs 23 completes a revolution every twenty minutes. When the rotating disks 212 of the circulating mechanisms 2 are rotating, water will flow through the water inlet holes 231 of those of the cultivation troughs 23 that are currently immersed in water of the breeding pool 1; thus, plants on the cultivation troughs 23 are provided with water and nutrients in water to grow. Therefore, the user is allowed to breed fish/domestic birds and cultivate plants on single piece of land, i.e. the breeding pool 1, at the same time.

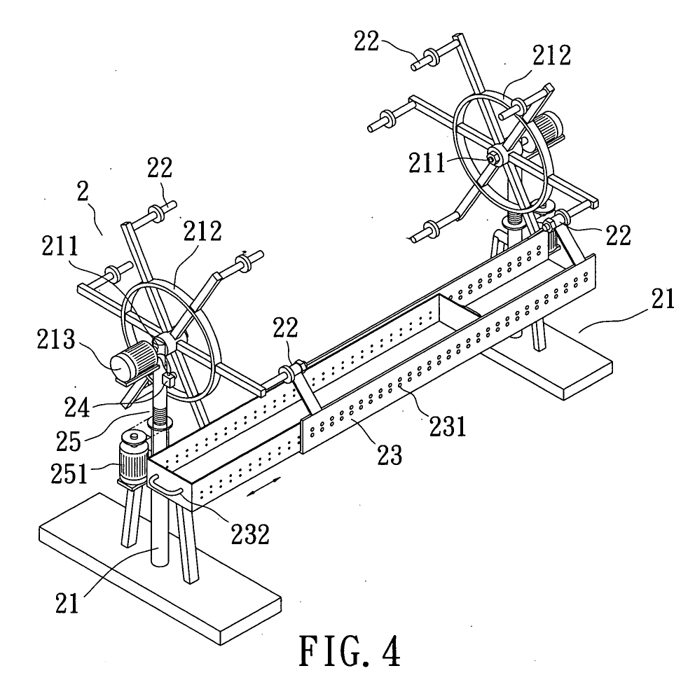

Referring to FIG. 4, the cultivation troughs 23 have doors 232 at two ends thereof, which can be pulled to an open position. Therefore, people are allowed to pull the doors 232 open so as to pick the harvest easily. From what has been said above, it can be seen that the present invention allows farmers to make full use of land resources; plants can be planted on the cultivation troughs 23, and cultivated and nourished with the various abundant nutrients contained in the water in the breeding pool 1, which is being used to breed fish/domestic birds.

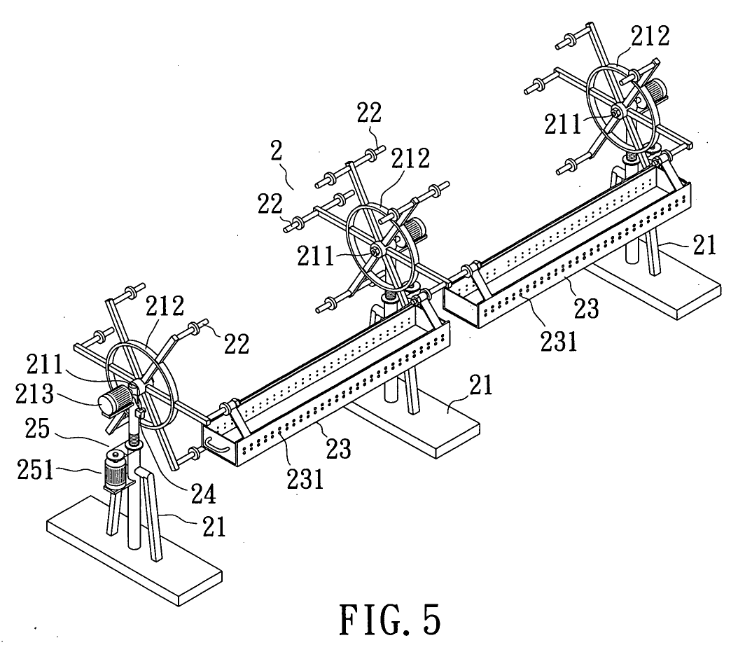

Kindly refer to FIG. 5, which is a perspective view of the circulating growing apparatus of the present invention in use. The quantity of the revolving support members 21 depends on the area of the breeding pool 1. The revolving supporting members 21 are positioned one next another in an equidistant manner while cultivation troughs 23 are positioned between every two adjacent ones of the revolving support members 21, and joined to the connecting parts 22 at two ends so as to made to circle by means of the revolving support members 21.

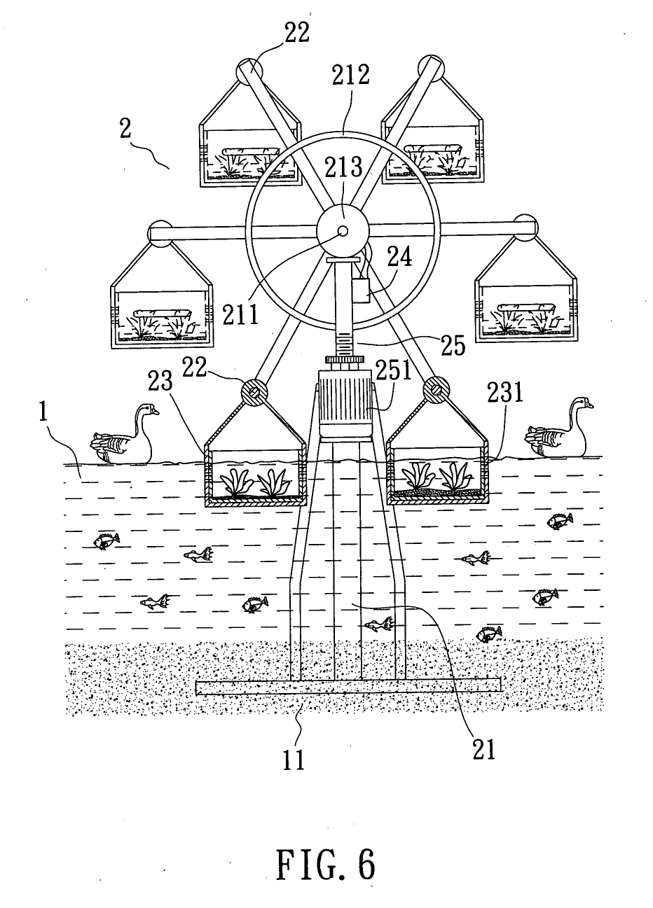

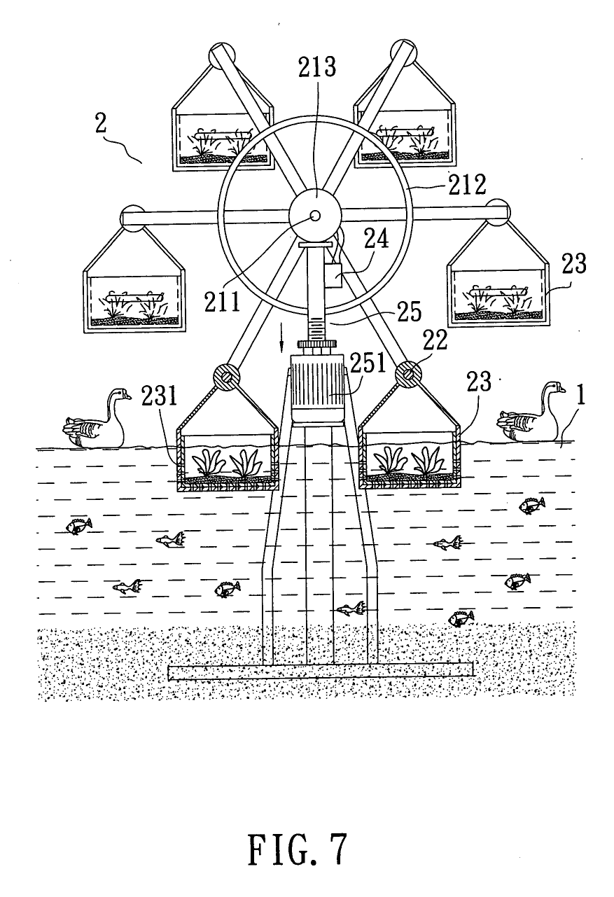

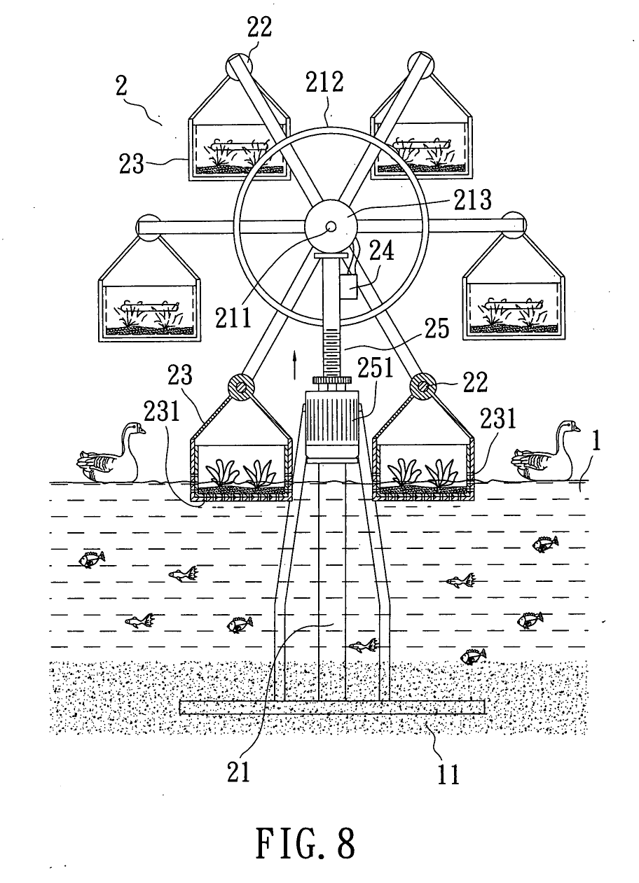

Shown in FIGS. 6, 7, and 8 is the second preferred embodiment of a circulating growing apparatus of the present invention; each of the rotating disks 212 of the revolving support members 21 is pivoted on a corresponding pivotal portion 211 at a central portion. Furthermore, the rotating disks 212 can be adjusted in height by means of adjustment units 25 fitted on the revolving support members 21, which adjustment unit 25 is powered by means of a power source 251 such as a motor, and a hydraulic/pneumatic pressure cylinder. The time series controlling device 24 also controls the power source 251 according to the height of the water surface in the breeding pool 1; thus, the power source 251 will move the rotating disks 212 up in order for the cultivation troughs 23 to be in contact with water in a proper manner when water surface gets higher. Similarly, the power source 251 will lower the rotating disks 212 in order for the cultivation troughs 23 when water surface gets lower.

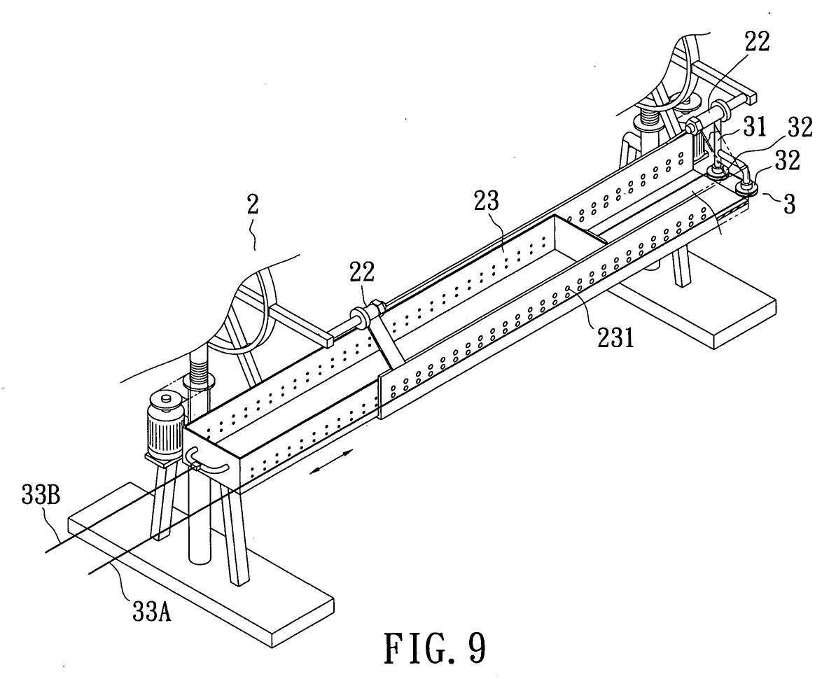

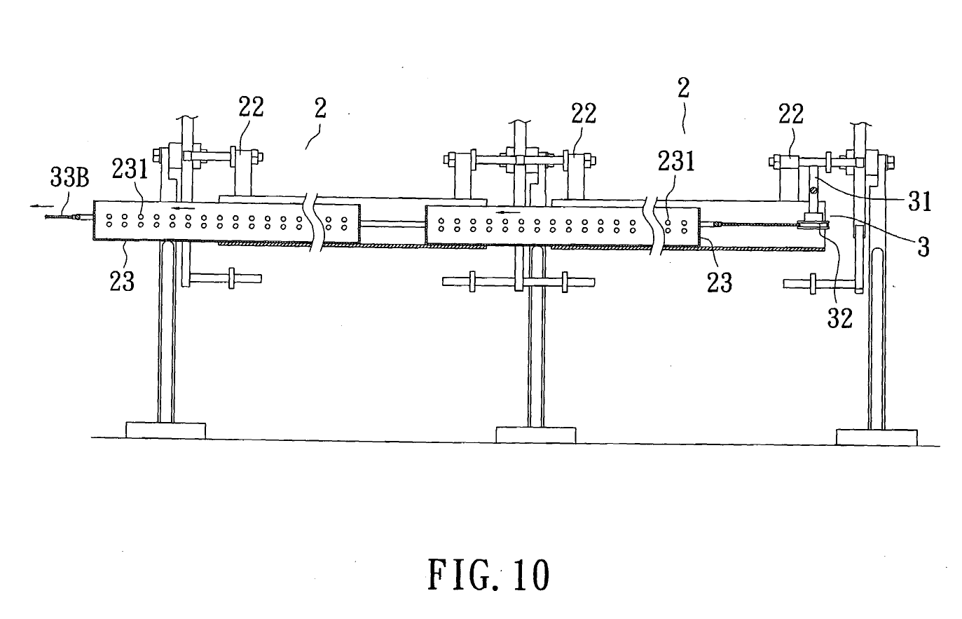

Kindly refer to FIGS. 9 and 10, which show the circulating growing apparatus in gathering the harvest/sowing; the cultivation troughs 23 can be each connected to a pulling and moving mechanism 3, which is used to move the cultivation trough 23 to such a position as to allow harvests to be gathered/seeds to be strewn on the cultivation trough 23 easily. Or alternatively, they can be divided into several groups, and each group of cultivation troughs 23 can be connected to one pulling and moving mechanism 3. Each of the connecting parts 22 of the revolving supporting members 21 has two supporting rods 31 sticking from a lower side thereof, and pulleys 32 are pivoted on the supporting rods 31 respectively, and a pulling rope 33A is passed over the two pulleys 32, connected to a door 232 at one end of the corresponding cultivation trough 23, and extends to the other (second) end of the cultivation trough 23. Furthermore, a pulling rope 33B is connected to a door 232 at the second end of the cultivation trough 23. Therefore, the cultivation troughs 23 can be moved onto the bank for picking harvests/strewing seeds by means of pulling the pulling ropes 33B. And, the cultivation troughs 23 can be moved back onto the circulating mechanisms 2 by means of pulling the pulling ropes 33A after harvest-picking and sowing are finished. Therefore, farmers are allowed to make full use of land resources; plants on the cultivation troughs 23 can be cultivated and nourished with the various abundant nutrients contained in the water in the breeding pool 1.

From the above description, it can be seen that the circulating growing apparatus of the present invention has the following advantages:

1. With the circulating growing apparatus, land resources can be used for cultivating plants and breeding fish/domestic birds at the same time. Therefore, the present circulating growing apparatus is ideal in terms of environmental protection.

2. Plants planted on the cultivation troughs can be nourished with water in the breeding pool, which contains various nutrients, e.g. nitrogen, phosphorous, potassium, carbon, hydrogen, oxygen, calcium, magnesium, sulfur, iron, zinc, boron, copper, chlorine, molybdenum, and manganese.

3. The circulating growing apparatus is equipped with a time series controlling device to control motion of the rotating disks according to various factors such as classifications of plants, soils, water cultivation, weather, and water quality such that the cultivation troughs will be immersed in water for a proper length of time and at a proper frequency; thus, cultivation of plants will progress in exactly the way the farmers plan.

4. The circulating growing apparatus is equipped with an adjustment unit for adjusting the height of the rotating disks, joined to the cultivation troughs. Therefore, the height of the cultivation troughs can be adjusted according to the height of the water surface in the breeding pool, thus preventing change of the water surface height from affecting the result of plant cultivation.

5. When the circulating mechanisms are working, motion of the cultivation troughs into and outside water in the breeding pool will promote growth of the plants on the cultivation troughs as growth hormones.

6. The plants will take and benefit from the nutrients in water of the breeding pool while soil in the breeding pool will be cleaned owing to the plants taking some substances in the breeding pool. In other words, it will also benefit fishes/domestic birds bred in/on the breeding pool to use the circulating growing apparatus of the present invention.

7. The cultivation troughs of the he circulating growing apparatus have the doors, which can be easily pulled open by means of the pulling and moving mechanism in order for harvest-picking and sowing to be easily carried out. Therefore, the present invention is convenient to use.

What is claimed is:

1. A circulating growing apparatus for breeding and cultivating together, comprising
a plurality of circulating mechanisms arranged in a breeding pool used to breed; the circulating mechanisms being capable of revolving 360°; the circulating mechanisms each including a plurality of revolving support members spreading in the breeding pool; each of the revolving support members including a plurality of equidistantly spaced connecting parts; and
a plurality of cultivation troughs for plants; the cultivation troughs being each joined at two ends thereof to corresponding said connecting parts of two adjacent ones of the revolving support members such that the cultivation troughs will come into contact with water in the breeding pool when the circulating mechanisms are revolving.

2. The circulating growing apparatus for breeding and cultivating together as recited in claim 1, wherein the revolving support members of the circulating mechanisms stick out from water surface of the breeding pool at an upper pivotal portion, and each of the pivotal portions has a rotating disk pivoting thereon; the cultivation troughs being equidistantly spaced, and joined to the rotating disks.

3. The circulating growing apparatus for breeding and cultivating together as recited in claim 2, wherein a power source is used to make the rotating disks rotate.

4. The circulating growing apparatus for breeding and cultivating together as recited in claim 2, wherein a time series controlling device is used to control a power source used to make the rotating disks rotate.

5. The circulating growing apparatus for breeding and cultivating together as recited in claim 3, wherein the power source of the rotating disks is a motor.

6. The circulating growing apparatus for breeding and cultivating together as recited in claim 1, wherein the cultivation troughs have a plurality of water inlet holes on two lateral sides thereof.

7. The circulating growing apparatus for breeding and cultivating together as recited in claim 1, wherein the cultivation troughs have a plurality of water inlet holes on a bottom thereof.

8. The circulating growing apparatus for breeding and cultivating together as recited in claim 1, wherein each of the cultivation troughs have doors at two ends thereof.

9. The circulating growing apparatus for breeding and cultivating together as recited in claim 1, wherein each of the revolving support members has an adjustment unit fitted thereon to adjust a height of the cultivation troughs according to a height of water surface in the breeding pool.

10. The circulating growing apparatus for breeding and cultivating together as recited in claim 1, wherein the adjustment units are powered by means of a power source.

11. The circulating growing apparatus for breeding and cultivating together as recited in claim 10, wherein a time series controlling device is used to control the power source used to power the adjustment units.

12. The circulating growing apparatus for breeding and cultivating together as recited in claim 10, wherein the power source is a motor.

13. The circulating growing apparatus for breeding and cultivating together as recited in claim 10, wherein the power source is a pressure cylinder.

14. The circulating growing apparatus for breeding and cultivating together as recited in claim 1, wherein a number of the revolving support members of each of the circulating mechanisms is more than two.

15. The circulating growing apparatus for breeding and cultivating together as recited in claim 1, wherein the cultivation troughs are connected to a pulling and moving mechanism, which is used to move the cultivation troughs to such a position as to allow harvest-gathering and sowing to be carried out.

16. The circulating growing apparatus for breeding and cultivating together as recited in claim 15, wherein a pivotal joint between a first end of each of the cultivation troughs and a corresponding said revolving support member has two supporting rods sticking under it; pulleys being pivoted on the supporting rods respectively; a first pulling rope being passed over the two pulleys, and connected to the first end of the cultivation trough as well as extending to a second end of the cultivation trough; a second pulling rope being connected to the second end of the cultivation trough.
